(19) United States
(12) Patent Application Publication
(10) Pub. No.: US 2013/0326877 A1
(43) Pub. Date: Dec. 12, 2013

(54) METHOD OF WORKING AN AIRFOIL USING ELEVATED TEMPERATURE CMT WELDING

(71) Applicant: William M. Rose, Warren, MA (US)

(72) Inventor: William M. Rose, Warren, MA (US)

(73) Assignee: UNITED TECHNOLOGIES CORPORATION, Hartford, CT (US)

(21) Appl. No.: 13/492,303

(22) Filed: Jun. 8, 2012

(51) Int. Cl. B23P 6/00; B23K 9/04

(52) U.S. Cl. 29/889.1; 29/402.01

(57) ABSTRACT

A method of adding base metal to a superalloy component is disclosed. The method comprises identifying a region deficient in base metal and preparing the region for base metal addition by exposing clean substrate metal in the site. Base metal is added to the site by cold metal transfer (CMT) gas metal arc welding. Successful addition of base metal is possible by performing the CMT gas metal arc welding on a preheated substrate.

### TECHNICAL FIELD

The present invention relates to turbines and, more particularly, to the addition of base metal to a turbine airfoil.

### BACKGROUND

During operation, turbine components experience multiple forms of wear due to their exposure to the extreme environment in the hot gas path of a turbine engine. Thermal cycling and constant impingement of the hot corrosive medium result in continuous and sporadic material removal. Thermal and chemical erosion results in general uniform wear while impact erosion, due to airborne particulates in the gas stream, cause localized material removal. Spallation of coatings due to thermal cycling and fatigue can locally expose vulnerable substrate material resulting in degradation due to burnouts and hot spots. Stress concentrations resulting from localized material removal can result in surface fractures that may propagate to critical dimensions.

Repairs, whether part of a routine maintenance schedule or necessitated by component failure, may result in the restoration of a worn component to original dimensions by the addition of new material to worn or otherwise damaged regions in order to allow it to return to service.

An accepted method of adding base metal to a turbine component during repair is by welding, either by the attachment of bulk replacement sections or by the direct addition of weld metal to build up and fill in surface imperfections such as cracks and other missing features.

Preferred prior art methods of welding include gas metal arc welding (GMAW) commonly referred to as metal inert gas (MIG) welding or metal active gas (MAG) welding. In GMAW, a consumable weld wire and a shielding gas are fed through a welding torch to supply filler metal to the weld. Weld speed, metal deposition rate, and metal spatter are common GMAW issues. Furthermore, the additions of large amounts of weld filler metal to newer superalloy components without cracking has been difficult. Cold metal transfer (CMT) welding is a recent technology developed by Fronius International GMBH, Pettenbach, Austria, that successfully addresses these problems.

A number of superalloys including Mitsubishi Heavy Industries: MGA 1400 alloy, are difficult to repair by welding. An improved method to repair these alloys would be beneficial.

### SUMMARY

According to the present invention, a method to work or repair a superalloy turbine component with, for example, surface damage includes first cleaning the component and removing appropriate coatings. The damage is then identified and the damaged region is readied for repair. Damage is removed and underlying base metal is exposed in preparation for deposition of supplemental or repair metal. The component is then given a stress relief anneal. Repair metal is deposited by cold metal transfer gas metal arc welding to a component that has been preheated to an elevated temperature to eliminate or minimize weld cracking. The component is then machined to original dimensions followed by a stress relief heat treatment.

In another embodiment, a method of restoring a damaged superalloy component having a surface is to first prepare a damaged area by exposing clean base metal at the damage site. After a stress relief anneal, repair metal is then added to the preheated damaged area by cold metal transfer welding to minimize weld cracking. The repair site is then machined to restore original component dimensions followed by a stress relief heat treatment.

### BRIEF DESCRIPTION OF THE DRAWINGS

FIG. 1 is a partial view of rotor blades attached to a disc.

FIGS. 2A-2D are schematics showing the repair process.

FIG. 3 is a flow chart of the repair process.

### DETAILED DESCRIPTION

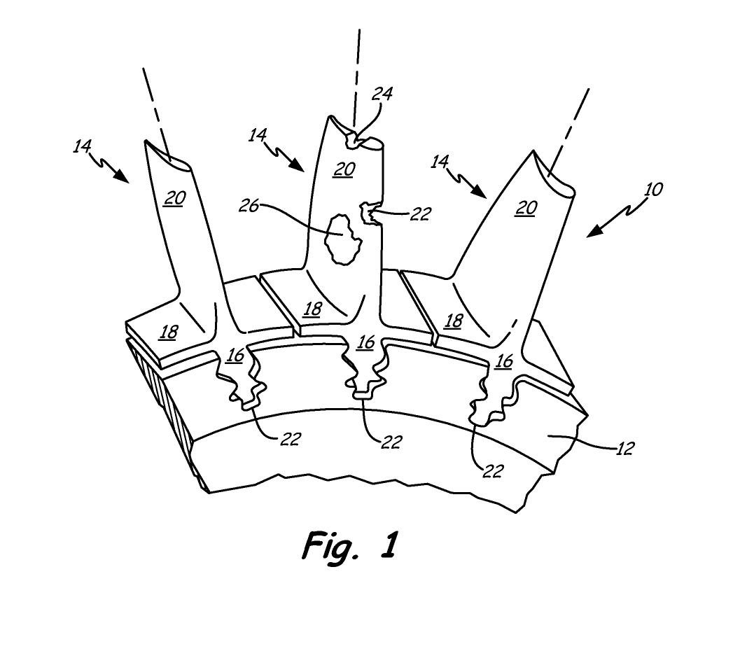

Exemplary work piece or rotor assembly 10 of a superalloy gas turbine engine is shown in FIG. 1. Rotor assembly 10 includes disc 12 and a plurality of rotor blades 14. Each rotor blade 14 includes a root 16, platform 18, and airfoil 20. Roots 16 are disposed in channels 22 positioned circumferentially around the perimeter of disc 12 to attach blades 14 to disc 12.

During operation of the gas turbine engine, airfoils 20 are exposed to the hot gas path of the engine and can sustain impact damage from solid objects in the gas stream, thermal damage including thermal barrier coating spallation from thermal cycling, and chemical damage from high temperature exposure to, for instance, salt and molten sand. Examples of airfoil damage are leading edge and tip damage schematically shown as wear sites 22 and 24 respectively and localized surface damage schematically shown as cavity 26.

Accepted methods of adding repair metal to turbine components include metal inert gas (MIG) welding and metal active gas (MAG) welding. Both techniques are used in the art, but weld metal spatter may result in added clean up. The Fronius cold metal transfer (CMT) arc welding process employs a feedback system, wherein as soon as the weld wire strikes an arc and leaves a weld deposit, the wire is retracted from the weld pool. Repeated cycling of the weld wire positioning during welding results in relatively “cold” welding, high weld material deposition rate, and minimum spatter.

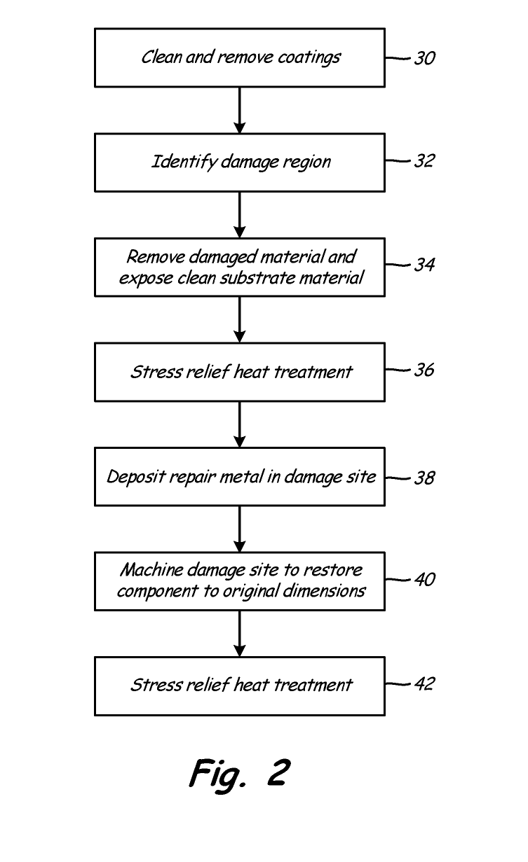

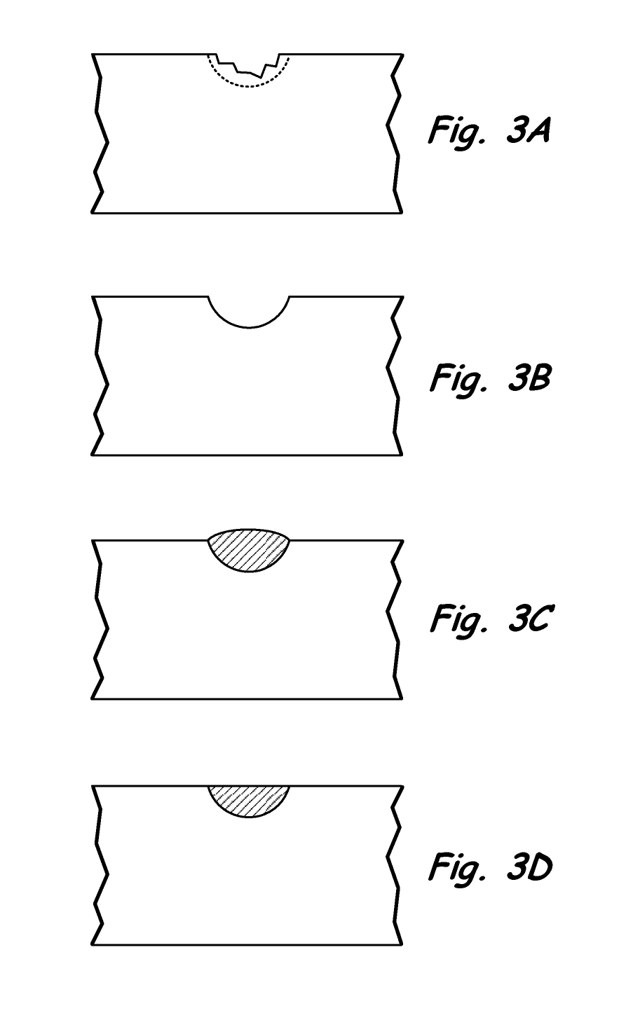

A flow chart of a repair process using elevated temperature CMT arc welding is shown in FIG. 2. In the first part of the process, the component is cleaned and protective coatings such as thermal barrier coatings are removed (Step 30). The component is then inspected to identify damage regions needing repair (Step 32). A schematic cross section of exemplary damaged cavity 26 needing repair in a superalloy turbine component during repair is shown in FIGS. 3A-3D to assist in the discussion.

After the initial cleaning, damaged region 26, as schematically shown in FIG. 3A, is identified. The area in and around region 26 is then prepared for repair by exposing clean base metal, typically by abrasive means as schematically shown by FIG. 3B (Step 34). The component under repair is then subjected to a stress relief heat treatment for temperatures and times appropriate for each repair (Step 36). In an embodiment, a preweld stress relief heat treatment is from about 1700° F. (927° C.) to about 2200° F. (1204° C.).

The component is then heated to a predetermined temperature and repair metal is added by elevated temperature CMT welding to the repair site, such that the profile of the repair exceeds the original profile of the component as shown in FIG. 3C (Step 38). Weld metal may be added by manual or automatic (eg. robotic) CMT welding procedures.

A number of nickel base, cobalt base, and iron base superalloys are difficult to weld. Conventional crack free weld repair of these superalloys is difficult, if not impossible, under ordinary low temperature welding conditions. Examples of these alloys and their respective filler metals include MGA 1400 alloy with PWA alloy 795 or Inconel 625 alloy filler, GTD 111 alloy with PWA 795 alloy filler, and PWA 1437 alloy with PWA 795 alloy filler. An inventive aspect of the present invention is to circumvent or minimize weld cracking by performing CMT weld repair on damaged superalloy components with the components maintained at elevated temperatures. These examples are by no means limiting and other beneficial applications and uses of the invention are anticipated. Examples of CMT weld filler metals and welding temperatures of the above exemplary superalloys are shown below.

| Alloy | Filler Metal | Welding Temperature |
|---|---|---|
| MGA 1400 | PWA 795 | 1700° F. (927° C.)-1800° F. (1037° C.) |
| | Inconel 625 | |
| GTD 111 | PWA 795 | 1700° F. (927° C.)-1800° F. (1037° C.) |
| | Inconel 625 | |
| PWA 1437 | PWA 795 | 1700° F. (927° C.)-1800° F. (1037° C.) |
| | Inconel 625 | |

Following elevated temperature CMT weld repair, the dimensions are restored to original design specifications by abrasive material removal, typically machining, as shown in FIG. 3D (Step 40).

The repaired component is then subjected to a stress relief heat treatment (Step 42) before coatings are applied and the component is returned to service.

Exemplary heat treatments following weld repair, for MGA 1400 alloy, GTD 111 alloy, and PWA 1437 alloy are listed below.

| Alloy | Stress Relief Heat Treatment |
|---|---|
| MGA 1400 | 1700° F. (927° C.)-2000° F. (1093° C.) in |
| | controlled atmosphere |
| GTD 111 | 1700° F. (927° C.)-2000° F. (1093° C.) in |
| | controlled atmosphere |
| PWA 1437 | 1700° F. (927° C.)-2000° F. (1093° C.) in |
| | controlled atmosphere |

While the invention, as indicated by FIG. 1, has been directed to turbine blade repair, it is to be understood that the invention is directed to damage repair in gas turbine engine components in general, in particular vanes, shrouds, casings, and other components.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

Discussion of Possible Embodiments

The following are non-exclusive descriptions of possible embodiments of the present invention.

A method of adding base metal to a superalloy component can include; identifying a region deficient in base metal; preparing the region for addition of the base metal; subjecting the component to a preweld stress relief heat treatment; heating the component to a weld temperature; adding base metal to the component by elevated temperature cold metal transfer welding to exceed the original dimensions of the component; machining the component to original size specifications and subjecting the component to a stress relief anneal.

The system of the preceding paragraph can optionally include additionally and/or alternatively any, one or more of the following features, configurations and/or additional components:

the superalloy can be one of a nickel based superalloy, a cobalt based superalloy, an iron based superalloy, or mixtures thereof;

the superalloy can be a nickel based superalloy from the group consisting of MGA 1400 alloy, GTD 111 alloy, and PWA 1437 alloy; the elevated temperature cold metal transfer welding can use PWA 795 or Inconel 625, weld filler material; the region can be prepared for addition of base metal by first removing all coatings and exposing clean metal substrate material in the vicinity of the weld site; the preweld stress relief heat treatment can be at temperatures from about 1700° F. (927° C.) to about 1800° F. (1037° C.);

the base metal weld addition temperature of the component during elevated temperature cold metal transfer welding is from about 1700° F. (927° C.) to about 1800° F. (1204° C.);

the elevated temperature cold metal transfer welding can utilize automatic cold metal transfer gas metal arc welding;

the post weld stress relief heat treatment can be at temperatures of from about 1700° F. (927° C.) to about 2000° F. (1093° C.);

the superalloy component can comprise a gas turbine component;

the gas turbine component can comprise a blade, vane, shroud, casing, or mixtures thereof.

A method of adding base metal to a superalloy component can comprise; identifying a region deficient in base metal; removing all coatings from the region of the component and exposing clean substrate material in the vicinity of the region that will accept the added base metal; annealing the component for stress relief; heating the component to a weld temperature; adding base metal to the component by elevated temperature cold metal transfer welding to exceed the original dimensions of the component; machining the component to original size specifications; and subjecting the component to a stress relief anneal.

The method of the preceding paragraph can optionally include, additionally and/or alternatively, any one or more of the following features and/or additional steps:

the elevated temperature cold metal transfer welding comprises automatic welding; the elevated temperature cold metal transfer welding comprises welding at a component temperature of from about 1700° F. (927° C.) to about 1800° F. (1037° C.); performing preweld stress relief at temperatures from about 1700° F. (927° C.) to about 1800° F. (1037° C.) and post weld stress relief at temperatures from about 1700° F. (927° C.) to about 2000° F. (1093° C.); the superalloy can be one of a nickel based superalloy, a cobalt based superalloy, an iron based superalloy, or mixtures thereof; the superalloy can be a nickel based superalloy from the group consisting of MGA 1400 alloy, GTD 111 alloy, and PWA 1437 alloy; the elevated temperature cold metal transfer welding can use PWA 795 or Inconel 625 weld filler metal; the superalloy component can comprise a gas turbine component; and the gas turbine component can comprise a blade, vane, shroud, casing, or mixtures thereof.

1. A method of adding base metal to a superalloy component, the method comprising:
identifying a region deficient in base metal;
preparing the region for addition of base metal;
subjecting the component to a preweld stress relief heat treatment;
heating the component to a weld temperature;
adding base metal to the component by elevated temperature cold metal transfer welding to exceed the original dimensions of the component;
machining the component to original size specifications; and
subjecting the component to a stress relief anneal.

2. The method of claim 1, wherein the superalloy is one of a nickel based superalloy, a cobalt based superalloy, an iron based superalloy, or mixtures thereof.

3. The method of claim 2, wherein the superalloy is a nickel based superalloy from the group consisting of MGA 1400 alloy, GTD 111 alloy, and PWA 1437 alloy.

4. The method of claim 3, wherein elevated temperature cold metal transfer welding uses PWA 795 or Inconel 625, weld filler metal.

5. The method of claim 1, wherein preparing the region for addition of base metal comprises first removing all coatings and exposing clean substrate material in the vicinity of the weld site.

6. The method of claim 1, wherein the preweld stress relief heat treatment is at temperatures from about 1700° F. (927° C.) to about 1800° F. (1037° C.).

7. The method of claim 1, wherein the base metal weld addition temperature of the component during elevated temperature cold metal transfer welding is from about 1700° F. (927° C.) to about 1800° F. (1204° C.).

8. The method of claim 1, wherein the elevated temperature cold metal transfer welding utilizes automatic cold metal transfer gas metal arc welding.

9. The method of claim 1, wherein the post weld stress relief heat treatment is at temperatures of from about 1700° F. (927° C.) to about 2000° F. (1093° C.).

10. The method of claim 1, wherein superalloy component comprises a gas turbine component.

11. The method of claim 10, wherein gas turbine component comprises a blade, vane, shroud, casing, or mixtures thereof.

12. A method of adding base metal to a superalloy component, the method comprising:
identifying a region deficient in base metal;
removing all coatings from the region of the component and exposing clean substrate material in the vicinity of the region that will accept the added base metal;
annealing the component for stress relief;
heating the component to a weld temperature;
adding base metal to the component by elevated temperature cold metal transfer welding to exceed the original dimensions of the component;
machining the component to original size specifications; and
subjecting the component to a stress relief anneal.

13. The method of claim 12, wherein the elevated temperature cold metal transfer welding comprises automatic welding.

14. The method of claim 12, wherein elevated temperature cold metal transfer welding comprises welding at a component temperature of from about 1700° F. (927° C.) to about 1800° F. (1037° C.).

15. The method of claim 12, and further comprising:
performing preweld stress relief at temperatures from about 1700° F. (927° C.) to about 1800° F. (1037° C.) and post weld stress relief at temperatures from about 1700° F. (927° C.) to about 2000° F. (1093° C.).

16. The method of claim 12, wherein the superalloy is one of a nickel based superalloy, a cobalt based superalloy, an iron based superalloy, or mixtures thereof.

17. The method of claim 16, wherein the superalloy is a nickel based superalloy from the group consisting of MGA 1400 alloy, GTD 111 alloy, and PWA 1437 alloy.

18. The method of claim 12, wherein elevated temperature cold metal transfer welding uses PWA 795 or Inconel 625 weld filler metal.

19. The method of claim 12, wherein the superalloy component comprises a gas turbine component.

20. The method of claim 19, wherein the gas turbine component comprises a blade, vane, shroud, casing, or mixtures thereof.
